(19) United States
(12) Patent Application Publication
(10) Pub. No.: US 2015/0251195 A1
(43) Pub. Date: Sep. 10, 2015

(54) FLUID DISPENSER WITH SELF-ALIGNING NOZZLE

(71) Applicants: Dazhang LIAO, Kwai Chung (HK); Hon Yu NG, Kwai Chung (HK); Xiong LI, Kwai Chung (HK); Tsz Kit YU, Kwai Chung (HK); Yuk Cheung AU, Kwai Chung (HK)

(72) Inventors: Dazhang LIAO, Kwai Chung (HK); Hon Yu NG, Kwai Chung (HK); Xiong LI, Kwai Chung (HK); Tsz Kit YU, Kwai Chung (HK); Yuk Cheung AU, Kwai Chung (HK)

(21) Appl. No.: 14/197,446

(22) Filed: Mar. 5, 2014

(51) Int. Cl. B05B 1/02; B05B 15/06

(52) U.S. Cl. CPC B05B 1/02; B05B 15/065

(57) ABSTRACT

Disclosed is a fluid dispenser, comprising a main body having an elongate bore formed therethrough; a dispensing rod having a tip, the dispensing rod being extendably movable along an axis of the elongate bore to dispense fluid; and a nozzle assembly comprising a nozzle having a contact surface that includes an exit orifice for dispensing the fluid from the elongate bore, and a nozzle holder for holding the nozzle. The nozzle is received by the main body to define a transverse gap that allows the nozzle to be movable transversely within the nozzle holder and with respect to the axis of the elongate bore to align the exit orifice with the dispensing rod, upon the tip of the dispensing rod being urged against the contact surface of the nozzle. Also disclosed is a nozzle assembly for a fluid dispenser, as well as a method of assembling a fluid dispenser.

### TECHNICAL FIELD

This invention relates to a fluid dispenser with a self-aligning nozzle, and a method of assembling the fluid dispenser.

### BACKGROUND

Fluid dispensers are widely used in industry, especially in the electronics manufacturing field, for dispensing viscous materials, such as solder fluxes, epoxy, silicon and so on. These dispensers can be classed according to their respective dispensing principles, such as time-pressure dispensing, rotary-screw dispensing, positive displacement dispensing, and jet dispensing.

In a dispensing system, the dispenser is typically mounted on a movable platform which provides automatic and accurate motion for the dispenser in three dimensions relative to the substrate to which material is to be applied. Alternatively, the motion can be realized by combining the movements of the platform and the substrate.

The choice of dispenser is mostly determined by the application requirements of the electronic manufacturing process. These might include the viscosity of the dispensed material, desired dispense pattern on the substrate, dispensed dot dimension, quantity of dispensed units per hour, selected dispensable area and so on. In some applications, each component on the substrate to which fluid is to be dispensed has a specific area, and is not permitted to contact the dispenser tip. In these applications, the dispenser must dispense droplets in a controlled manner at a certain non-contact distance from the substrate. Dispensers with such a capability are usually called jet dispensers, dot jetting machines, or jet pumps.

Normally, a jet dispenser comprises an actuator, a fluid chamber, a nozzle, a nozzle holder, a piston, a syringe and several seals. The actuator provides reciprocating movement to the piston by connecting or coupling with the piston. Presently, several kinds of actuators are known, such as pneumatic, piezo-electrical, and linear solenoid valve actuators. The fluid chamber is connected with the syringe, where the fluid is pressurized by compressed air so as to have a constant flow rate to supply viscous fluid to the nozzle through the fluid path between the syringe and the fluid chamber. The nozzle may be removable, and is typically held or pressed by the nozzle holder by screwing or clamping to contact the fluid chamber tightly. Alternatively, if the nozzle is not removable, it may be integrated into one part with the nozzle holder. During a dispensing operation, the actuator moves the piston and imparts sufficient momentum to the fluid in the fluid chamber to force droplets through the exit orifice of the nozzle, while the viscous fluid is supplied into the fluid chamber continuously from the syringe.

One of the critical performance criteria for jet dispensers is repeatability. This refers to the droplet variation under the same dispensing parameters after re-assembling the nozzle or fluid chamber. Re-assembly is typically required periodically due to cleaning of the dispenser. The variation of the alignment between the piston and the nozzle after each disassembly and re-assembly may influence the repeatability. Such variation can also have a significant effect on the jetting capability.

Currently known jet dispensers usually adopt special positioning parts, such as linear bearings, plastic guides, or static seals in order to precisely align the piston and nozzle. The alignment is realized by very fine machining and assembly tolerances or by using special tools. Fine tolerances need precise machinery and very skilled technicians, which increases the machining complexity. Also, complex machining processes may also cause operating parameters of the dispensing process to depart from desired parameters. Additionally, the positioning parts will inevitably be subject to abrasion since they are in constant contact with the piston during its reciprocating movement. Once the abrasion reaches a certain threshold, the positioning parts will cease to be effective.

The present invention seeks to at least partly overcome one or more of the above problems.

### SUMMARY

Certain embodiments of the invention relate to a fluid dispenser, comprising:
a main body having an elongate bore formed therethrough;
a dispensing rod having a tip, the dispensing rod being extendably movable along an axis of the elongate bore to dispense fluid; and
a nozzle assembly comprising a nozzle having a contact surface that includes an exit orifice for dispensing the fluid from the elongate bore, and a nozzle holder for holding the nozzle, the nozzle being received by the main body to define a transverse gap that allows the nozzle to be movable transversely within the nozzle holder and with respect to the axis of the elongate bore to align the exit orifice with the dispensing rod, upon the tip of the dispensing rod being urged against the contact surface of the nozzle.

Other embodiments relate to a nozzle assembly for a fluid dispenser, the fluid dispenser comprising a main body having an elongate bore formed therethrough, a dispensing rod having a tip, the dispensing rod being extendably movable along an axis of the elongate bore to dispense fluid, and a nozzle coupling section, the nozzle assembly comprising:
a nozzle having a contact surface that includes an exit orifice; and
a nozzle holder for holding the nozzle,
wherein the nozzle is receivable in the nozzle coupling section to define a transverse gap that allows the nozzle to be movable transversely with respect to the axis of the elongate bore to align the exit orifice of the nozzle with the dispensing rod, upon the tip of the dispensing rod being urged against the contact surface of the nozzle.

Further embodiments relate to a method of assembling a fluid dispenser, the method comprising the steps of:
providing a dispenser body having an elongate bore formed therethrough, a dispensing rod having a tip, the dispensing rod being extendably movable along an axis of the elongate bore to dispense fluid, and a nozzle coupling section;
providing a nozzle assembly which comprises a nozzle having a contact surface that includes an exit orifice, and a nozzle holder for holding the nozzle;
partially retracting the tip of the dispensing rod;
coupling the nozzle holder to the nozzle coupling section to define a transverse gap that allows the nozzle to be movable transversely with respect to the axis of the elongate bore to align the exit orifice of the nozzle with the dispensing rod, upon the tip of the dispensing rod being urged against the contact surface of the nozzle;
restricting movement of the nozzle along the axis of the elongate bore;
extending the tip of the dispensing rod to contact the contact surface of the nozzle, thereby moving the nozzle transversely within the nozzle holder and with respect to the axis of the elongate bore; and
repeatedly retracting and extending the tip until the exit orifice of the nozzle is aligned with the axis of the dispensing rod.

### BRIEF DESCRIPTION OF THE DRAWINGS

Embodiments of the invention will now be described, by way of non-limiting example only, with reference to the accompanying drawings in which:

FIG. 1 is a cross-sectional view through a fluid dispensing apparatus according to certain embodiments of the invention;

FIG. 2 is a close-up view of part of the apparatus of FIG. 1; and

FIG. 3 is a flow diagram of a process for assembling a fluid dispensing apparatus.

### DETAILED DESCRIPTION

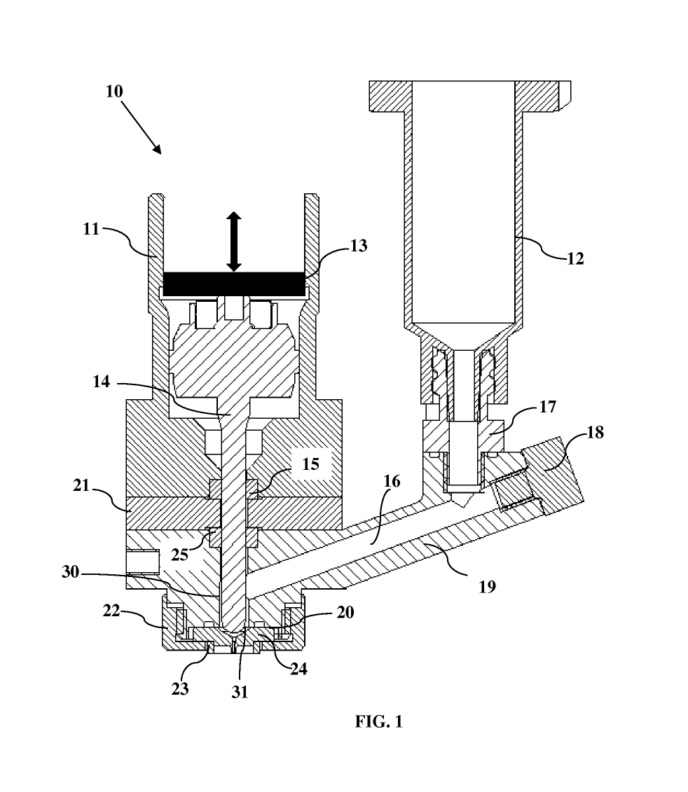

Referring to FIG. 1, there is shown an embodiment of a fluid dispenser (in this embodiment, a jet dispenser) 10. The fluid dispenser 10 has a main body comprising a support frame or upper chamber 11 and a fluid chamber 19 coupled to the support frame 11. The fluid chamber 19 stores and provides fluid.

Interposed between the support frame 11 and fluid chamber 19 is a layer or block of thermally insulating material 21. The insulation block 21 advantageously prevents or substantially reduces transfer of heat from the support frame 11 to the fluid chamber 19, thus preventing fluid in the fluid chamber 19 from being heated, which might otherwise affect its physical properties and thus add variability to droplets of fluid dispensed from the fluid dispenser 10.

Housed within the support frame 11 is an actuator 13 for providing up-and-down reciprocating movement of a movable piston rod (also referred to herein as a dispensing rod) 14 within an elongate bore 30 which terminates at a fluid dispensing end 31. The piston rod 14 moves along an axis (not shown) of the elongate bore 30. The actuator 13 may be any suitable actuator known in the art, for example a piezoelectric actuator, a pneumatic actuator or a linear solenoid valve actuator. Operation of the actuator 13 may be controlled by a programmable microcontroller (not shown) of known design.

On either side of the insulation block 21, and surrounding the piston rod 14, are seals 15 and 25 for preventing ingress of fluid into the upper chamber 11.

The fluid chamber 19 comprises a fluid inlet channel 16 which is in fluid communication with the elongate bore 30. The fluid inlet channel 16 is inclined with respect to the horizontal. Fluid from a syringe 12 (which may store solder flux, adhesive or other viscous liquids) continuously flows into the fluid inlet channel 16 and down the incline of the fluid inlet channel 16, and, when the piston rod 14 is retracted, flows into the elongate bore 30 and is available for dispensing on a down-stroke of the piston rod 14. An end seal 18 is arranged at an end of the fluid inlet channel 16 that is opposite to the elongate bore 30 to prevent egress of the fluid from the fluid inlet channel 16.

Coupled to the lower end of fluid chamber 19 is a nozzle assembly, including a nozzle holder 22 and a nozzle 24 which is housed within an internal space defined between the nozzle holder 22 and the fluid chamber 19, with nozzle 24 abutting against a contact surface 20 of the fluid chamber 19. The nozzle holder 22 is preferably attached to the fluid chamber 19 by a nozzle coupling section (shown as a threaded neck 38 connection).

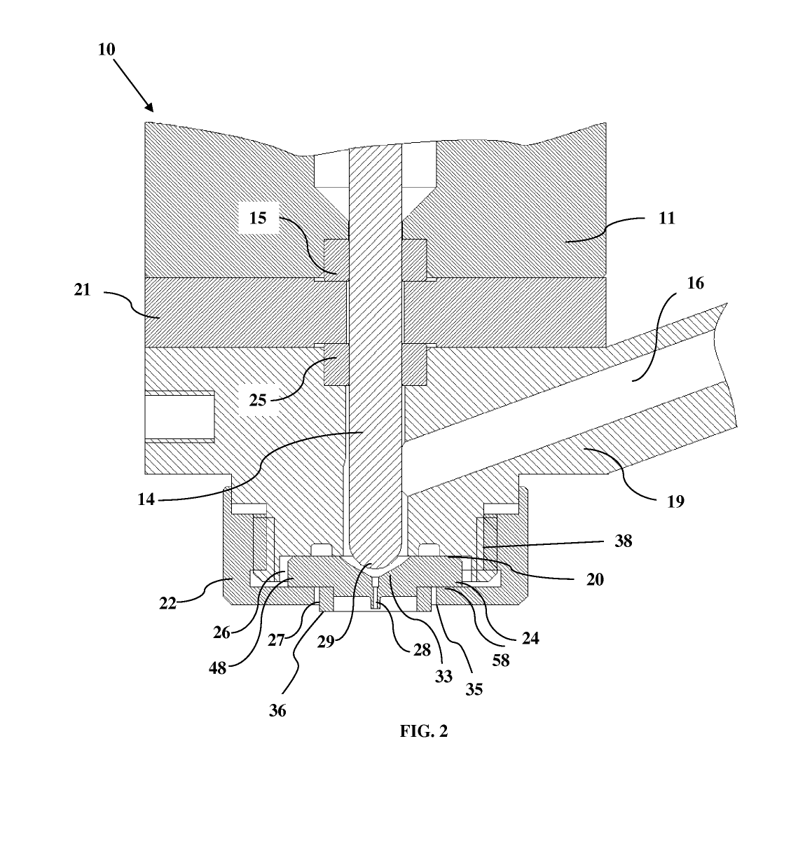

As shown in FIG. 2, the nozzle 24 comprises a circular collar 48 having a curved surface portion 33, a protruding section 36 extending from the circular collar 48 and an orifice 28. The orifice 28 is located at the centre of the curved surface portion 33 of the circular collar 48. The nozzle holder 22, on the other hand, comprises an aperture 35 through which the protruding section 36 of the nozzle 24 is fitted. As the diameter of the circular collar 48 is larger than the width of the aperture 35, a contact surface 58 of the nozzle holder 22 abuts against the circular collar 48 to prevent the nozzle 24 from sliding through the aperture 35. Moreover, when the nozzle holder 22 and the nozzle 24 are in place on the lower end of the fluid chamber 19, a transverse gap 26 is defined between an outer perimeter of the nozzle 24 and an inner surface of the fluid chamber 19. This is because the width of the internal space (as defined by the nozzle holder 22 and the fluid chamber 19) is larger than the diameter of the circular collar 48 of the nozzle 24. Likewise, an additional transverse gap 27 is formed between the protruding section 36 and the aperture 35, because the width of the aperture 35 is larger than the diameter of the protruding section 36 of the nozzle 24. In consequence, the nozzle 24 is movable laterally within the defined internal space, to the extent allowed by transverse gaps 26, 27, for self-alignment of the orifice 28 with the piston rod 14. Each gap 26, 27 is preferably larger than about 20 um.

The curved surface portion 33 is a concave indentation formed in the nozzle 24, and has a shape which is complementary to the curved shape of the tip 29 of the piston rod 14. Due to the presence of transverse gap 26 (between the nozzle 24 and the fluid chamber 19) and the transverse gap 27 (between the nozzle holder 22 and the nozzle 24), the nozzle 24 is movable in lateral directions within the nozzle holder 22 such that a downward extension of the piston rod 14 along the elongate bore 30 urges the surface portion 33 of the nozzle 22 transversely (i.e. orthogonal to the bore axis) to align the orifice 28 with the piston rod 14. As such, the mating curved surfaces 33 and 29 together provide a self-alignment feature for the nozzle 24, to ensure that the orifice 28 is substantially aligned with the piston rod 14, and thereby ensuring greater consistency of droplet ejection during operation of the fluid dispenser 10 or between disassembly and re-assembly of the fluid dispenser 10.

As shown in FIG. 1 and FIG. 2, the contact surface 33 may be a truncated sphere or truncated spheroid. The curved surface 33 may also have alternative shapes, such as a conical shape, e.g., an inverted cone with its apex located at the entry to the exit orifice 28.

It will be appreciated that the curved surface 33 need not be concave, and in fact in some embodiments may be convex. In such embodiments, the tip 29 of the piston rod 14 may have the opposite curvature than that shown in FIG. 1 and FIG. 2 (i.e., be concave) in order to mate with the convex curved surface 33 and provide the self-alignment feature.

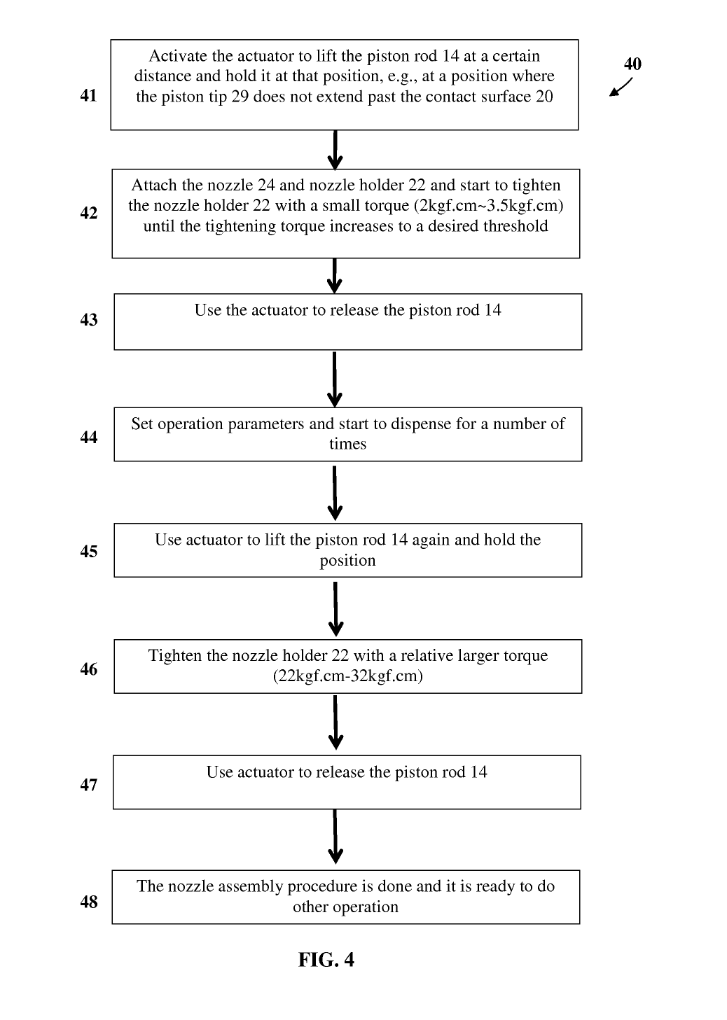

Referring now to FIG. 3, there is shown an embodiment of a method 40 of assembling the fluid dispenser 10.

The method 40 begins with the nozzle holder 22 detached from the remainder of the fluid dispenser 10 (i.e., detached from the fluid chamber 19). At step 41, the actuator 13 of the fluid dispenser 10 retracts the piston rod 14 such that it is at a distance above the intended position of the curved surface 33 (i.e., the position of the curved surface 33 when the nozzle holder 22 is attached), and holds the piston rod 14 at that position. Preferably, the piston rod 14 is retracted until its tip 29 is retracted beyond the contact surface 20 of the fluid chamber 19.

At step 42, the nozzle 24 is placed adjacent to the fluid chamber 19 and the nozzle holder 22 is placed on the threaded neck 38, and screwed onto the neck 38 until the circular collar 48 of the nozzle 24 is lightly secured against the contact surface 20 of the fluid chamber 19, as well and against the contact surface 58 of the nozzle holder 22, with a small torque (e.g. 2 kgf.cm -3.5 kgf.cm). The tightening torque applied by nozzle holder 22 is preferably increased until it reaches a desired threshold (e.g. 2 kgf.cm-3.5 kgf.cm).

At step 43 the actuator 13 extends the piston rod 14 such that the tip 29 of piston rod 14 contacts the curved surface 33 of the nozzle 24. Then, at step 44, jetting operation parameters (such as stroke and open/close time) of the fluid dispenser 10 are set (for example, by programming the microcontroller), and the fluid dispenser 10 commences a number of consecutive jetting operations, for example, 100 times or 50 times. If there is any misalignment between the exit orifice 28 of the nozzle 24 and the axis of the elongate bore 30 of the fluid dispenser 10, the repeated impact of the tip 29 of the piston rod 14 on the curved surface 33 during the consecutive jetting operations will tend to move the nozzle 24 laterally within the gap 26 (since the nozzle 24 is only lightly held between the nozzle holder 22 and contact surface 20), as previously described, thus aligning the exit orifice 28 with the piston rod 14.

At step 45 the microcontroller of fluid dispenser 10 instructs the actuator 13 to retract the piston rod 14 again, for example to its earlier retracted position, and to hold it at that position. At this point the nozzle holder 22 can be tightened with a relatively larger torque (e.g. 22 kgf.cm-32 kgf.cm) so as to securely hold the nozzle 24 against the contact surface 20 (step 46). Then, at step 47, the actuator 13 can be instructed to extend the piston 14 again. At this point the alignment procedure of the exit orifice 28 of the nozzle 24 and the piston rod 14 is finished and the fluid dispenser 10 is ready for dispensing operations (step 48).

Embodiments of the invention can self-align the nozzle 24 with the piston rod 14 very precisely during assembly as well as during dispensing. Moreover, due to the complementary shapes of the nozzle surface and the piston rod tip, the variation of the aligned position after respective re-assemblies is very small, which improves the repeatability of the fluid dispenser 10. The alignment can be realised in a very easy and convenient manner. In addition, the center positions of the piston rod 14 and the nozzle 24 can be aligned automatically, without the use of special measurement tools to perform alignment calibration, and without requiring fine tolerances and special guiding parts. The nozzle holder 22, the nozzle 24 and the piston rod 14 can be manufactured very easily and with coarse tolerances. By avoiding fine tolerances it is possible to eliminate precise positioning parts which continually contact and have abrasion with the piston rod 14. Thus, embodiments of the invention reduce the cost and increase the abrasion lifetime of the piston.

Although particular embodiments of the invention have been described in detail, many modifications and variations are possible within the scope of the invention, as will be clear to a skilled reader.

1. A fluid dispenser, comprising:
a main body having an elongate bore formed therethrough;
a dispensing rod having a tip, the dispensing rod being extendably movable along an axis of the elongate bore to dispense fluid; and
a nozzle assembly comprising a nozzle having a contact surface that includes an exit orifice for dispensing the fluid from the elongate bore, and a nozzle holder for holding the nozzle, the nozzle holder being received by the main body to define a transverse gap that allows the nozzle to be movable transversely within the nozzle holder and with respect to the axis of the elongate bore to align the exit orifice with the dispensing rod, upon the tip of the dispensing rod being urged against the contact surface of the nozzle.

2. The fluid dispenser according to claim 1, wherein the contact surface of the nozzle has a shape which is at least partly complementary to a shape of the tip of the dispensing rod.

3. The fluid dispenser according to claim 1, wherein the nozzle further comprises a circular collar abutting against a contact surface of the nozzle holder to house the nozzle within the nozzle holder.

4. The fluid dispenser according to claim 3, wherein the nozzle further comprises a protruding section extending from the circular collar, the protruding section being configured and arranged such that a second transverse gap is defined between the protruding section of the nozzle and the nozzle holder.

5. The fluid dispenser according to claim 1, further comprising a fluid chamber for storing and providing the fluid to the elongate bore, the fluid chamber being in fluid communication with the elongate bore and the exit orifice of the nozzle.

6. The fluid dispenser according to claim 5, wherein an insulating layer is disposed between the main body and the fluid chamber.

7. The fluid dispenser according to claim 5, wherein a fluid inlet channel is formed in the fluid chamber.

8. A nozzle assembly for a fluid dispenser, the fluid dispenser comprising a main body having an elongate bore formed therethrough, a dispensing rod having a tip, the dispensing rod being extendably movable along an axis of the elongate bore to dispense fluid, and a nozzle coupling section, the nozzle assembly comprising:
a nozzle having a contact surface that includes an exit orifice; and
a nozzle holder for holding the nozzle,
wherein the nozzle is receivable in the nozzle coupling section of the fluid dispenser to define a transverse gap that allows the nozzle to be movable transversely within the nozzle holder and with respect to the axis of the elongate bore to align the exit orifice of the nozzle with the dispensing rod, upon the tip of the dispensing rod being urged against the contact surface of the nozzle.

9. The nozzle assembly according to claim 8, wherein the nozzle has a contact surface with a shape that is at least partly complementary to a shape of the tip of the dispensing rod.

10. The nozzle assembly according to claim 8, wherein the nozzle further comprises a circular collar abutting against a contact surface of the nozzle holder to house the nozzle within the nozzle holder.

11. The nozzle assembly of claim 10, wherein the nozzle further comprises a protruding section extending from the circular collar, the protruding section being configured and arranged such that a second transverse gap is defined between the protruding section of the nozzle and the nozzle holder.

12. A method of assembling a fluid dispenser, comprising the steps of:
providing a dispenser body having an elongate bore formed therethrough, a dispensing rod having a tip, the dispensing rod being extendably movable along an axis of the elongate bore to dispense fluid, and a nozzle coupling section;
providing a nozzle assembly comprising a nozzle having a contact surface that includes an exit orifice, and a nozzle holder for holding the nozzle;
partially retracting the tip of the dispensing rod;
coupling the nozzle holder to the nozzle coupling section to define a transverse gap that allows the nozzle to move transversely within the nozzle holder and with respect to the axis of the elongate bore;
restricting movement of the nozzle within the nozzle holder;
extending the tip of the dispensing rod to contact the contact surface of the nozzle, thereby moving the nozzle transversely with respect to the axis of the elongate bore; and
repeatedly retracting and extending the tip of the dispensing rod until the exit orifice of the nozzle is aligned with the dispensing rod.

13. The method according to claim 12, further comprising the step of further restricting the movement of the nozzle within the nozzle holder after the exit orifice of the nozzle has been aligned with the dispensing rod.
